(19) United States
(12) Patent Application Publication
(10) Pub. No.: US 2016/0170196 A1
(43) Pub. Date: Jun. 16, 2016

(54) OPTICAL OBSERVATION APPARATUS AND METHOD FOR OPERATING AN OPTICAL OBSERVATION APPARATUS

(71) Applicant: Carl Zeiss Meditec AG, Jena (DE)

(72) Inventors: Lisa ROSSMANN, Aalen (DE); Stefan ERNSPERGER, Ellwangen (DE); Ulrich GOLD, Aalen (DE)

(21) Appl. No.: 14/962,830

(22) Filed: Dec. 8, 2015

(30) Foreign Application Priority Data
Dec. 11, 2014 (DE) 10 2014 118 382.7

(51) Int. Cl. G02B 21/36; G02B 21/00; G02B 21/18; G02B 27/09; H04N 5/225; G06T 11/60

(52) U.S. Cl. CPC G02B 21/361; H04N 5/225; G06T 11/60; G02B 21/18; G02B 21/365; G02B 27/0905; G02B 21/0012

(57) ABSTRACT

A method for operating an optical observation apparatus (1) comprising at least one eyepiece (23), at least one camera (25) and an observation beam path (3) for displaying an object field image (45) is provided. In the method, a superimposition beam path (4) representing an electronically generated superimposition image (43) is superposed onto the observation beam path (3), wherein the observation beam path (3), onto which the superimposition beam path (4) has been superposed, has one eyepiece branch (17) leading to the at least one eyepiece (23) and one camera branch (19) leading to the at least one camera (25). The at least one camera (25) records an image on the basis of the camera branch (19). The electronically generated superimposition image (43) is only generated in a specific spectral range, or restricted to such a spectral range, which is substantially not also recorded by the at least one camera when recording the image or which is removed from the camera branch (19) prior to recording the image with the at least one camera (25) or which is removed from the image recorded by the at least one camera (25) after recording the image using the at least one camera (25).

The present invention relates to an optical observation apparatus, in particular an operation microscope, comprising at least one eyepiece and at least one camera. Additionally, the invention relates to a method for operating an optical observation apparatus, in particular an operation microscope.

Optical observation apparatuses such as e.g. operation microscopes often have one or two eyepieces for directly observing an object field image obtained from an object field. Additionally, at least one camera is often present, which camera likewise records the object field image obtained from the object field. Moreover, optical observation apparatuses can be equipped with a mirroring-in module, with the aid of which images or information are mirrored into the observation beam path. By way of example, when necessary, images or data are superposed onto the object field image in operation microscopes in order to impart additional information to the treating surgeon. Here, the images could have been generated by means of an imaging method such as, for example, a tomography method or obtained with the aid of a further optical observation apparatus, for example an endoscope. Data that are superimposed into the object field image can be e.g. alphanumerical data or graphical data. Here, graphical data can serve, for example, to mark specific regions in the object field image and, for example, be contours surrounding specific object regions or color marks coloring specific object regions.

In some optical observation apparatuses, the camera is, for systemic reasons, arranged in such a way that it records the object field image which has been superposed with the superimposed images or data. By way of example, such an optical observation apparatus is described in DE 10 2004 038 001 A1. Recording the object field image which has been superposed with the superimposition image may lead to difficulties when evaluating the object field image, particularly if the image recorded by the camera constitutes the basis for an automated image evaluation. Moreover, the superimposition image can lead to bothersome feedback effects in the object field image if the image recorded by the camera serves as a basis for the superimposition image. Therefore, cameras are sometimes arranged in such a way in the prior art that the object field image is decoupled from the beam path before the superimposition image is superposed on the beam path. By way of example, a corresponding operation microscope is described in EP 2 199 842 A1. However, such a configuration requires more installation space than a configuration in which the object field image already superposed with data to be superimposed or the image to be superimposed is presented to the camera.

It is therefore an object of the present invention to provide a method for operating an optical observation apparatus, in which an object field image, onto which a superimposition image has been superposed, is fed to a camera, by means of which the aforementioned difficulties are at least partly overcome. It is a further object to provide an advantageous optical observation apparatus.

The first object is achieved by a method for operating an optical observation apparatus as claimed in claim 1; the second object is achieved by an optical observation apparatus as claimed in claim 9. The dependent claims contain advantageous configurations of the invention.

In the method according to the invention for operating an optical observation apparatus comprising at least one eyepiece, at least one camera and an observation beam path for displaying an object field image, a superimposition beam path representing an electronically generated superimposition image is superposed onto the observation beam path. Here, the observation beam path, onto which the superimposition beam path has been superposed, has an eyepiece branch leading to the at least one eyepiece and a camera branch leading to the at least one camera, and the at least one camera records an image on the basis of the camera branch. The electronically generated superimposition image is only generated in a specific spectral range, or restricted to such a spectral range, which is substantially not also recorded by the at least one camera when recording the image or which is removed from the camera branch prior to recording the image with the at least one camera or which is removed from the image recorded by the at least one camera after recording the image using the at least one camera. To the extent that the spectral range is not removed from the camera branch prior to the incidence on the camera, the fact that the specific spectral range is substantially not also recorded by the at least one camera when recording the image can be achieved by virtue of the sensitivity of the camera being low in that spectral range in which the electronically generated superimposition image is generated or the camera not having any sensitivity at all in this spectral range. By way of example, in this case the electronically generated superimposition image can be a color image, predetermined by the specific spectral range, with a reduced color spectrum, such as e.g. a single-color image. However, the electronically generated superimposition image can also be a grayscale value image, particularly when the specific spectral range is the whole visible spectral range or comprises at least two complementary colors.

As a result of the electronic superimposition image being generated in a specific spectral range or being restricted to the specific spectral range not contained in the image recorded by the camera, the image recorded by the camera can be evaluated and/or be made the basis of the superimposition image, without the difficulties set forth at the outset occurring.

It is advantageous if the specific spectral range is not present in the object field image or only present with a low intensity such that the fact that this spectral range is missing from the image generated by the camera does not substantially impair the optical impression of the observation object situated in the object field. Moreover, it can be advantageous if the specific spectral range is a narrowband spectral range compared with the spectral range of the object field image. Here, in particular, the narrowband spectral range should make up no more than ⅓ of the spectral range of the object field image recorded by the camera, preferably no more than ⅕, more preferably no more than 1/10.

The specific spectral range is a section from the visible spectral range, particularly, but not only, if the electronic superimposition image is envisaged for observation with the aid of the eyepiece.

In a first specific configuration of the method according to the invention, the spectral range in the image recorded by the at least one camera is restricted to 475 to 510 nm and 525 to 700 nm or a section thereof. In particular, the spectral range in the image recorded by the at least one camera can be restricted to 475 to 510 nm and 525 to 600 nm or a section thereof.

In a second specific configuration of the method according to the invention, the spectral range in the image recorded by the at least one camera is restricted to 480 to 600 nm or a section thereof. In particular, the spectral range in the image recorded by the at least one camera can be restricted to 500 to 550 nm or a section thereof.

In a third specific configuration of the method according to the invention, the spectral range in the image recorded by the at least one camera is restricted to 430 to 470 nm and 600 to 750 nm or a section thereof. In particular, the spectral range in the image recorded by the at least one camera can be restricted to 600 to 750 nm or a section thereof, for example 620 to 750 nm or a section thereof, 620 to 660 nm or a section thereof, or 650 to 750 nm or a section thereof.

In a fourth specific configuration of the method according to the invention, the spectral range in the image recorded by the at least one camera is restricted to 800 to 1000 nm. In particular, the spectral range in the image recorded by the at least one camera can be restricted to 803 to 960 nm or a section thereof.

In the described four specific configurations, the specific spectral range is a section from the visible spectral range which lies outside of the spectral range in the image recorded by the at least one camera.

As becomes clear from the specific configurations, the specific spectral range and the spectral range in the image recorded by the at least one camera can, in particular, have a mutually complementary configuration.

While the two first specific configurations are suitable for e.g. fluorescence applications in which the observation of the fluorescence is substantially carried out in the green to red spectral range (500 to 700 nm), the third specific configuration is suitable e.g. for fluorescence applications in which the observation of the fluorescence is carried out substantially in the blue spectral range (450 to 470 nm) or in the orange to red spectral range (600 to 750 nm) and the fourth specific configuration is suitable e.g. for fluorescence applications in which the observation of the fluorescence is substantially carried out in the infrared spectral range (800 to 1000 nm). In the latter case, an infrared image recorded by the camera is converted into a visible image, for example a specific color image or a grayscale value image, which is then superposed onto the object field image as a superimposition image. By contrast, superimposition images which e.g. represent contours or colored markers in the fluorescence images can be superimposed in the first two alternatives.

In a specific configuration of the method according to the invention, the superimposition image is generated on the basis of the image recorded by the at least one camera. Since the superimposition image is present in a specific spectral range, which is not found in the image recorded by the camera, it is possible to avoid feedback between the superimposition image and the image recorded by the camera. In one development of this configuration, the specific spectral range can be the visible spectral range or a section thereof. The spectral range in the image recorded by the at least one camera then comprises the infrared spectral range and does not comprise the visible spectral range or the section of the visible spectral range which forms the specific spectral range. The image recorded by the camera is converted into an image in the visible spectral range or in the section of the visible spectral range forming the specific spectral range, which image then serves as the electronically generated superimposition image. The superimposition beam path representing the electronically generated superimposition image is superposed onto the observation beam path in such a way that the electronically generated superimposition image is adapted to the dimension and position of the object field image. As a result, it is possible to present to the user of the optical observation apparatus infrared data in the form of a superimposition image representing the infrared data, which has been superimposed into the object field image in a congruent fashion. Here, the image in the visible spectral range or in the section of the visible spectral range forming the specific spectral range, into which the recorded image is converted, can be e.g. a grayscale value image, a color image with one or more colors or a contour image.

An optical observation apparatus according to the invention comprises
at least one eyepiece,
at least one camera for recording images, wherein the camera can be realized by merely a camera chip in the simplest case,
an observation beam path for displaying an object field image,
at least one display which forms the initial point of a superimposition beam path representing an electronic superimposition image,
an optical superposition device for superposing the superimposition beam path onto the observation beam path, wherein the superposition device can be embodied e.g. as a beam splitter, and
a beam splitter for forming an eyepiece branch, leading to the at least one eyepiece, of the observation beam path, onto which the superimposition beam path has been superposed, and a camera branch, leading to the at least one camera, of the observation beam path, onto which the superimposition beam path has been superposed, wherein, in particular, the beam splitter can be identical to the optical superposition device.

In the optical observation apparatus according to the invention, the electronically generated superimposition image is only generated in a specific spectral range, or restricted to such a spectral range. Generating the electronically generated superimposition image only in a specific spectral range or restricting the electronically generated superimposition image to the specific spectral range is brought about by virtue of
the at least one display being a display which can merely emit in the specific spectral range or
a display controller being assigned to the at least one display, which display controller actuates said display for generating the electronically generated superimposition image in such a way that it only emits in the specific spectral range or
a filter which only passes the specific spectral range being disposed downstream of the at least one display.

Moreover, the spectral range in the image recorded by the at least one camera is restricted by virtue of
the at least one camera not being sensitive to the specific spectral range or the sensitivity of the camera being substantially lower to the specific beam range than in other spectral ranges recorded by the camera, or
a filter for filtering out the specific spectral range from the camera branch of the observation beam path, onto which the superimposition beam path has been superposed, being present between the beam splitter and the at least one camera, or
an image processing unit being present, which removes the specific spectral range from the image recorded by the at least one camera.

The electronically generated superimposition image can e.g. also be a grayscale value image, particularly if the specific spectral range is the whole visible spectral range or comprises at least two complementary colors.

If the sensitivity of the camera to the specific spectral range is significantly lower than in other spectral ranges recorded by the camera, the sensitivity to the specific spectral range is typically less than ⅓ of the sensitivity to the remaining spectral ranges recorded by the camera, preferably less than ⅕ and more preferably less than 1/10 of the sensitivity to the remaining spectral ranges recorded by the camera.

Using the optical observation apparatus according to the invention, it is possible to carry out the method according to the invention. As a result, it is possible to realize the features and advantages described with reference to the method. Since the beam splitter in the optical observation apparatus according to the invention can moreover form the superposition device for superposing the superimposition beam path onto the observation beam path at the same time, a compact optical observation apparatus in which the superimposition image is not also recorded by the camera is possible.

In the optical observation apparatus according to the invention, the at least one camera can be sensitive in the visual spectral range and/or in the infrared spectral range. If no filter is present in the camera branch of the observation beam path, onto which the superimposition beam path has been superposed, and if no image processing unit which removes the specific spectral range from the image recorded by the at least one camera is present either, the spectral range of the camera has a band, in which the camera is not sensitive or in which the sensitivity of the camera is low, wherein this band then corresponds to the specific spectral range in which the superimposition image is generated.

In a first specific configuration of the optical observation apparatus according to the invention, the spectral range in the image recorded by the at least one camera is restricted to 475 to 510 nm and 525 to 700 nm or a section thereof. In particular, the spectral range in the image recorded by the at least one camera can be restricted to 475 to 510 nm and 525 to 600 nm or a section thereof. In a second specific configuration of the optical observation apparatus according to the invention, the spectral range in the image recorded by the at least one camera is restricted to 480 to 600 nm or a section thereof. In particular, the spectral range in the image recorded by the at least one camera can be restricted to 500 to 550 nm or a section thereof. In a third specific configuration of the optical observation apparatus according to the invention, the spectral range in the image recorded by the at least one camera is restricted to 430 to 470 nm and 600 to 750 nm or a section thereof. In particular, the spectral range in the image recorded by the at least one camera can be restricted to 600 to 750 nm or a section thereof, for example 620 to 750 nm or a section thereof, 620 to 660 nm or a section thereof or 650 to 750 nm or a section thereof. In a fourth specific configuration of the optical observation apparatus according to the invention, the spectral range in the image recorded by the at least one camera is restricted to 800 to 1000 nm. In particular, the spectral range in the image recorded by the at least one camera can be restricted to 803 to 960 nm or a section thereof. In all the described specific configurations, the specific spectral range is a section from the visible spectral range which lies outside of the spectral range in the image recorded by the at least one camera. If the restriction of the spectral range is not implemented in the camera, the restriction is achieved by disposing a spectral filter upstream thereof or disposing an image processing unit downstream thereof.

In the optical observation apparatus according to the invention, an image evaluation unit connected to the at least one camera for receiving the recorded image can be present, which image evaluation unit generates a superimposition image from the recorded image. The image evaluation unit is connected to the display for displaying the generated superimposition image. This configuration of the optical observation apparatus is particularly suitable if the generated superimposition image is intended to reproduce objects which are recorded by the camera in a non-visible spectral range and it is therefore necessary to generate a superimposition image in the visible spectral range from the camera image. By way of example, this is the case if fluorescence in the infrared spectral range is intended to be observed. In this case, the infrared fluorescence light is recorded by the camera and the image generated thereby is completely or partly converted into e.g. a grayscale value image or any color image with one or more colors by the image evaluation unit, which converted image is then reproduced on the display as a superimposition image. In order to realize this, the optical observation apparatus according to the invention can, in particular, be configured in such a way that the specific spectral range is the visible spectral range or a section thereof and the spectral range in the image recorded by the at least one camera comprises the infrared spectral range and does not comprise the visible spectral range or the section of the visible spectral range forming the specific spectral range. Then, to this end, the image evaluation unit is configured to convert the image recorded by the camera into an image in the visible spectral range or in the section of the visible spectral range which forms the specific spectral range, and to output the image in the visible spectral range or in the section of the visible spectral range which forms the specific spectral range to the at least one display. Here, the at least one display is arranged and/or actuated in such a way that, when the superimposition beam path is superposed onto the observation beam path, the electronically generated superimposition image is adapted to the dimension and position of the object field image. Here, the image in the visible spectral range or in the section of the visible spectral range forming the specific spectral range, into which the recorded image is converted, can be e.g. a grayscale value image or a contour image.

In the optical observation apparatus according to the invention, the observation beam path can be a stereoscopic beam path. Additionally or alternatively, the superimposition beam path can be a stereoscopic beam path.

In particular, the optical observation apparatus according to the invention can be configured as an operation microscope.

Further features, properties and advantages of the present invention emerge from the following description of exemplary embodiments, with reference being made to the attached figures.

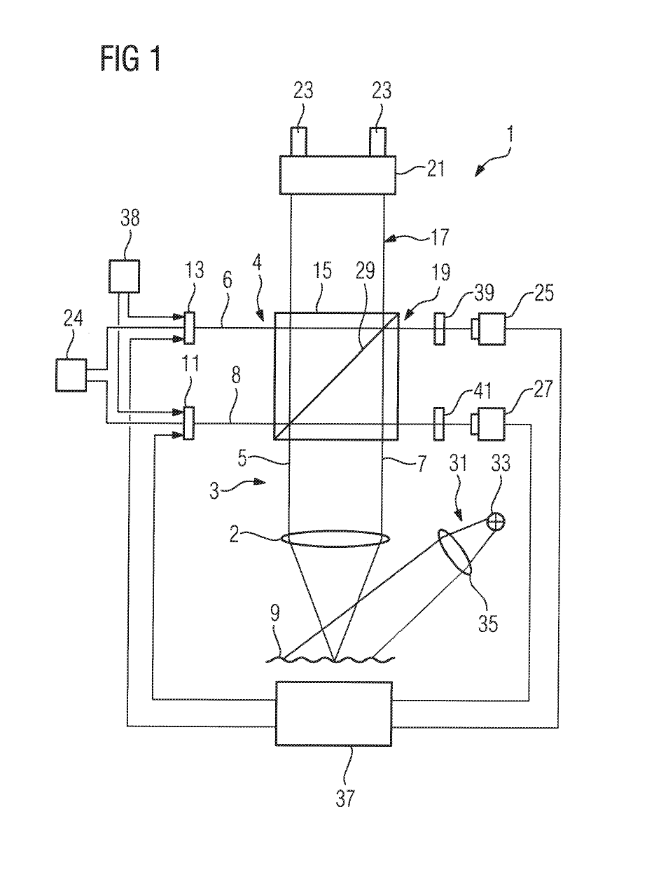

FIG. 1 schematically shows an operation microscope as an exemplary embodiment of an optical observation apparatus according to the invention.

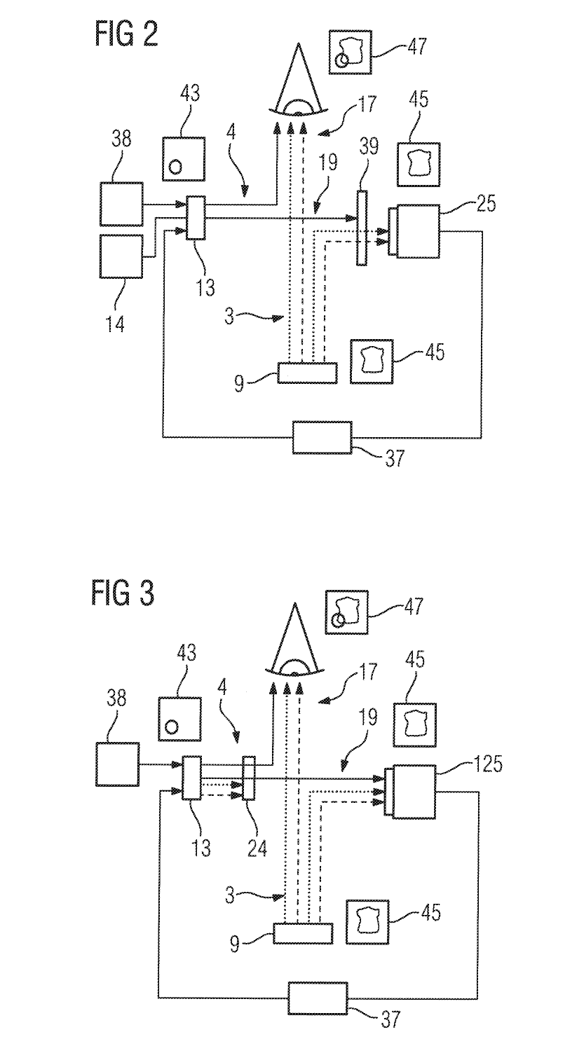

FIG. 2 shows a schematic sketch for explaining a first exemplary embodiment of the method according to the invention for operating an optical observation apparatus.

FIG. 3 shows a schematic sketch of an optical observation apparatus for explaining a second exemplary embodiment of the method according to the invention for operating an optical observation apparatus.

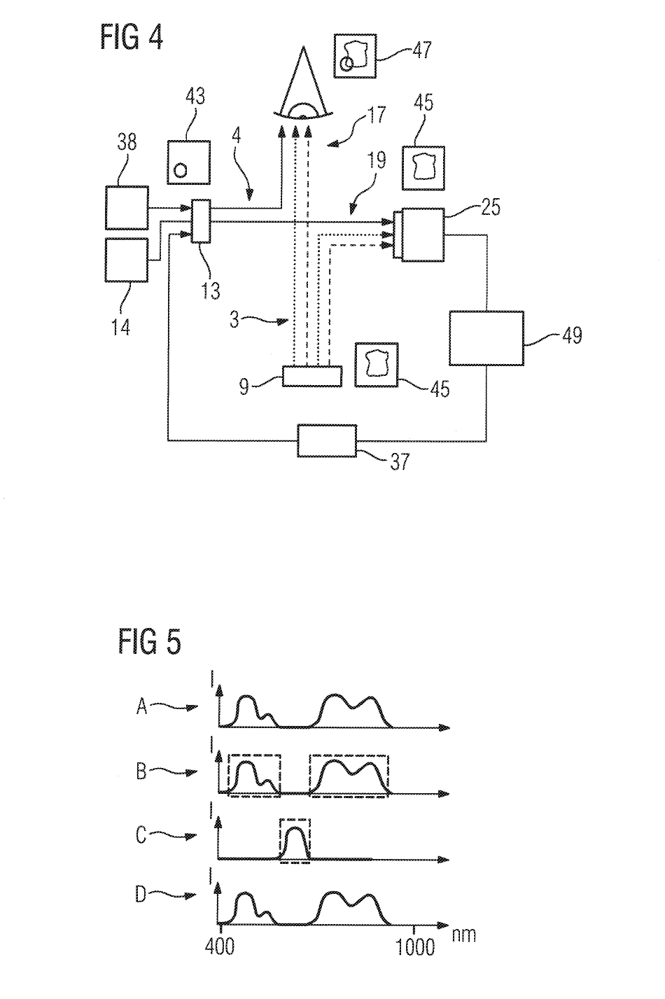

FIG. 4 shows a schematic sketch of an optical observation apparatus for explaining a third exemplary embodiment of the method according to the invention for operating an optical observation apparatus.

FIG. 5 shows the intensity characteristics of the object field image, the camera and the superimposition image and the object field image, onto which the superimposition image has been superposed, for one exemplary embodiment of the invention.

FIG. 1 shows, as an example of an optical observation apparatus according to the invention, an operation microscope, embodied according to the invention, in a schematic illustration. The operation microscope 1 has an observation beam path 3 comprising a first stereoscopic partial beam path 5 and a second stereoscopic partial beam path 7, which render it possible to observe a stereoscopic object field image of an object field 9. Furthermore, the operation microscope 1 comprises two displays 11, 13, with the aid of which a stereoscopic superimposition image can be generated. A beam splitter 15 serves as superposition device for superposing the superimposition beam path 4, which emanates from the displays 11, 13 and has stereoscopic partial beam paths 6, 8, onto the observation beam path 3. Moreover, the operation microscope 1 comprises a binocular tube 21 with two eyepieces 23, to which the observation beam path, optionally superposed with the superimposition beam path, is supplied for visual observation of the stereoscopic object field image, optionally superposed with a stereoscopic superimposition image. Moreover, two cameras 25, 27 are present, which are likewise supplied to the observation beam path, optionally with the superimposition beam path superposed thereon.

In order to feed the object field image, onto which a superimposition image has optionally been superposed, to the binocular tube 21 and the cameras 25, 27, the beam splitter 15, in addition to superposing the superimposition image onto the object field image, also serves to divide the observation beam path and the superimposition beam path in such a way that an eyepiece branch 17 and a camera branch 19 of the observation beam path, onto which the superimposition beam path has been superposed, are generated. To this end, the beam splitter 15 is embodied as a beam splitter cube, which has such dimensions that it is penetrated by the two stereoscopic partial beam paths 5, 7 of the observation beam path 3 and the two stereoscopic partial beam paths 6, 8 of the superimposition beam path 4. At a diagonal surface, the stereoscopic partial beam paths respectively incident on the surface are partly reflected and partly transmitted in order to bring about the split into the eyepiece branch 17 and the camera branch 19.

The operation microscope 1 moreover comprises an illumination device 31 with a broadband light source 33 and an illumination optical unit depicted schematically as a lens element 35. The illumination device serves to illuminate the object field 9. Although the illumination device 31 is equipped with a broadband light source 33 in the present exemplary embodiment, it can additionally, or alternatively, be equipped with a light source which only emits in a restricted wavelength range.

For simplicity, only the main lens 2 is depicted of the imaging optical unit of the operation microscope 1 forming the object field image. It is understood that the operation microscope 1 may comprise further optical elements, such as e.g. a magnification changer, for example in the form of a zoom system or a magnification changer with lens element combinations that are alternately insertable into the beam path.

In the present exemplary embodiment, the operation microscope 1 moreover comprises an image evaluation unit 37, to which the stereoscopic image recorded by the cameras 25, 27 is fed. In a special embodiment variant of the invention, which is depicted in the figures, the image evaluation unit 37 for the stereoscopic image establishes the information to be superimposed into the object field image, which is then forwarded to the displays 11, 13 for superimposing said information in the object field image. However, the image evaluation unit 37 can also merely serve to provide image evaluation for external applications.

Additionally or alternatively, the displays 11, 13 can generate superimposition images, which do not originate from the image evaluation unit 37. To this end, said displays are connected to a control unit 38, not depicted in the figure, which retrieves the data or images to be superimposed from external devices and feeds these to the displays 11, 13.

Information to be superimposed may be in the form of e.g. contour lines, colored markings of specific regions, annotations, etc.

If the image evaluation unit 37 is intended to evaluate the object field image, superimposed image or text data can make this evaluation more difficult or even impossible. As a result of using the beam splitter 15 both as superposition device for superposing the superimposition beam path 4 onto the observation beam path 3 and for generating the eyepiece branch 17 and the camera branch 15 of the observation beam path 3, onto which the superimposition beam path 4 has been superposed, it is not possible to avoid the observation beam path 3, to which the superimposition beam path 4 has been superposed, being fed to the cameras 25, 27. Although the superposition function and the splitting function of the beam splitter cube 15 could be distributed to two separate beam splitter cubes, this would lead to an increase in the installation space of the operation microscope 1. However, compactness is an important feature, particularly in the case of operation microscopes, and so splitting the superposition function and the splitting function to two beam splitter cubes cannot readily be realized.

In order to avoid the cameras 25, 27 recording the superimposition image, spectral filters 39, 41 are present in the camera branch 19 of the observation beam path 3, onto which the superimposition beam path 4 has been superposed. Moreover, the displays 11, 13 are actuated by a display controller 14 in the present exemplary embodiment in such a way that they merely emit in a specific spectral range, for example only in the blue spectral range, only in the green or only in the red spectral range, and so the superimposition image is merely generated in the specific spectral range by the displays 11, 13. In the present exemplary embodiment, this specific spectral range is filtered out of the camera branch 19 of the observation beam path 3, onto which the superimposition beam path 4 has been superposed, by way of the spectral filters 39, 41. In this manner, the observation beam path 3, onto which the superimposition beam path 4 has been superposed, does not contain the spectral range in which the superimposition image is generated at the location of the cameras 25, 27. Therefore, the superimposition image cannot be recorded by the cameras 25, 27 and it does not interfere with the evaluation of the object field image by the image evaluation unit 37. This is depicted schematically in FIG. 2. Said figure shows the observation beam path 3, the superimposition beam path 4, the eyepiece branch 17 and the camera branch 19 of the observation beam path, onto which the superimposition beam path has been superposed, a display 13 with a display controller 14 for generating the superimposition image 43 and a camera 25 for recording the object field image 45. The second display and the second camera have been omitted in the figure for simplicity. However, reference is made here to the fact that the optical observation apparatus according to the invention need not necessarily be embodied as a stereoscopic optical observation apparatus. In this case, the optical observation apparatus merely comprises one camera and one display, as depicted in FIG. 2.

When operating an optical observation apparatus in accordance with the embodiment of the invention depicted in FIG. 2, a superimposition image 43, which is fed both to the eyepiece branch 17 and the camera branch 19, as is also the case in the operation microscope from FIG. 1, is generated by means of the display 13. The superimposition image 43 is generated in a specific spectral range, which is represented by the full lines in FIG. 2. The object field image 45 comprises a broad spectral range, which is represented by the differently dashed lines in FIG. 2. Like the superimposition beam path 4 representing the superimposition image 43, the observation beam path 3 representing the object field image 45 is fed to both the eyepiece branch 17 and the camera branch 19, and so an observation beam path 3, onto which a superimposition beam path 4 has been superposed, is present in both branches.

The specific spectral range of the superimposition beam path 4 is filtered out of the camera branch 19 of the observation beam path 3, onto which the superimposition beam path 4 has been superposed, by means of the filter 39, and so only the observation beam path 3 reaches the camera, without the spectral range of the superimposition beam path 4.

If the spectral range of the observation beam path 3 likewise comprises the specific spectral range in which the superimposition image is generated, color distortions and/or intensity losses occur in the object field image 45 recorded by the camera due to the filtering-out of this spectral range. Therefore, in order to keep the color distortions and/or intensity losses as low as possible, it is advantageous if the specific spectral range, in which the superimposition image 43 is generated, is narrowband compared to the spectral range, in which the object field image 45 is present, and/or merely present with a low intensity in the object field image 45. As a result, the color distortions and/or intensity losses can be kept low. An example for corresponding spectral intensity profiles in the object field image 45, in the superimposition image 43 and in the object field image 47, onto which the superimposition image has been superposed, to be observed at the eyepieces and also for the spectral distribution of the light reaching the camera 25 is depicted in FIG. 5. While diagram A reproduces the spectral intensity profile in the object field image 45, diagram B reproduces those spectral ranges which reach the camera 25 and diagram C reproduces the spectral range in which the superimposition image 43 is generated. Then, diagram D shows the spectral characteristic of the object field image 47, onto which the superimposition image 43 has been superposed, to be observed in the eyepiece branch 17. Specifically, the specific spectral range of the superimposition image 43 can be e.g. 470 to 600 nm or a narrower spectral range lying between 470 to 600 nm and the filter characteristic of the filter 39 can be selected in such a way that it does not pass the specific wavelength range. If use is then made of a camera 25, which has a sensitivity in the range from 430 to 750 nm, the object field image is recorded in the spectral range from 430 to 470 nm and from 600 to 750 nm. If a narrower spectral range lying between 470 to 600 nm is used as a specific spectral range, e.g. 500 to 550 nm, the filter 39 can be configured in such a way that it only does not pass this narrower spectral range. Then, the object field image could be recorded by the camera 25 in the spectral range from 430 to 500 nm and from 550 to 750 nm.

As described, restricting the superimposition image 43 to the specific spectral range can be brought about by virtue of the display 13 being actuated by a display controller 14 in such a way that the superimposition image is only generated in the specific spectral range. Alternatively, the display 13 can be embodied in such a way that it can only emit in the specific spectral range, i.e., for example, only in the blue spectral range, only in the green or only in the red spectral range. To this end, the display 13 can be constructed from e.g. only blue, green or red LEDs. However, restricting the superimposition image 43 generated by the display to the specific spectral range by a suitable actuation by means of a display controller 14 is advantageous due to the increased flexibility.

A second embodiment of the invention is depicted in FIG. 3. Elements corresponding to the elements from FIG. 2 are denoted by the same reference signs as in FIG. 2 and will not be explained once again in order to avoid repetition. Therefore, the description of the second embodiment restricts itself to the differences in relation to the first embodiment.

In contrast to the first embodiment depicted in FIG. 2, the spectral range of the superimposition image 43 is restricted to the specific spectral range in the second embodiment depicted in FIG. 3 by virtue of a spectral filter 24 disposed downstream of the display 13, which spectral filter merely passes the specific spectral range. Moreover, in the depicted embodiment, no spectral filter is present in the camera branch 19 of the observation beam path 3, onto which the superimposition beam path 4 has been superposed. Rather, the specific spectral range and the spectral sensitivity of the camera 125 are matched to one another in such a way that the camera 125 only has a very restricted sensitivity or, preferably, no sensitivity in the spectral range in which the superimposition image 43 is generated by the display 13. By way of example, the superimposition image can be generated in the wavelength range of 400 to 475 nm, wherein the camera 125 then has e.g. a restricted sensitivity in the range from 525 to 700 nm. An alternative option consists of generating the superimposition image in the spectral range from 400 to 700 nm, i.e. in the visible spectral range, and of using a camera, the sensitivity of which lies in the infrared spectral range, in particular in the range between 800 and 1000 nm, as camera 125. Naturally, other combinations of a specific spectral range in which the superimposition image is generated and the spectral range in which the camera 125 is sensitive are possible.

A third embodiment of the invention is depicted in FIG. 4. Like in FIG. 3, the elements in FIG. 4 corresponding to those elements from FIG. 2 are denoted by the same reference signs as in FIG. 2 and will not be explained once again in order to avoid repetition. The description of the embodiment depicted in FIG. 4 is therefore also restricted to the differences in relation to the embodiment depicted in FIG. 2.

The third embodiment depicted in FIG. 4 differs from the embodiment depicted in FIG. 2 by virtue of the filter 39 not being present. Instead, an image processing unit 49 is disposed downstream of the camera 25, which image processing unit removes the specific spectral range, in which the superimposition image 43 is generated, from the image recorded by the camera 25. The image 45 recorded by the camera 25 is only fed to the image evaluation unit 37 after the specific spectral range has been removed. In this manner, the image evaluation unit 37 receives an object field image which does not contain a superimposition image.

Independent of the embodiments depicted in FIGS. 2 to 4, the present invention can be used e.g. to convert a fluorescence image available in the infrared spectral range into an image available in the visible spectral range, e.g. a grayscale value image or a contour image, by way of the image evaluation unit 37 and to reproduce this image lying in the visible spectral range in such a way on the display 13 that it is adapted to the dimension and position of the object field image 45. Since the camera 25 records a fluorescence image lying in the infrared spectral range, the sensitivity of said camera can be restricted to the infrared spectral range such that it does not acquire the superimposition image depicted by the display 13 in the visible spectral range. In this manner, the infrared image recorded by the camera is not influenced by the superimposition image 43. By contrast, the eyepieces can be used to observe an object field image 45 in the visible spectral range, onto which the superimposition image 43 reproducing the infrared fluorescence, e.g. a grayscale value image representing the fluorescence, is superposed. However, in addition to this application, other applications are also possible, in particular those in which both the image recorded by the camera and the superimposition image lie in the visible spectral range. By way of example, if a fluorescence is intended to be observed in the yellow spectral range, a superimposition image can be generated in the blue spectral range and the camera can e.g. record an object field image with a spectral characteristic in the range from 525 to 700 nm (by means of a filter disposed upstream thereof or by means of a spectrally restricted sensitivity of the camera) or the recorded image can be restricted to this spectral range by image processing. By contrast, the image observed by the eyepieces contains the complete spectral range from 400 to 700 nm, and so both the object field image and the superimposition image can be observed through the eyepieces.

In alternatives, the fluorescence image can lie in the blue spectral range. In this case, it is possible, for example, to generate a superimposition image which lies in the spectral range from 490 to 600 nm. The camera would then record an image in the spectral range from 430 to 490 nm and in the spectral range from 600 to 750 nm (by means of a filter disposed upstream thereof or by means of a spectrally restricted sensitivity of the camera) or the recorded image would be restricted to this spectral range by image processing. By contrast, at the eyepieces it would be possible to observe an image in the whole spectral range from 430 to 750 nm, i.e. the object field image together with the superimposition image.

The present invention was described in detail for explanation purposes on the basis of exemplary embodiments. A person skilled in the art recognizes that details described in relation to one embodiment can also be used in other embodiments. By way of example, in the embodiments described in relation to FIGS. 2 and 4, use can be made of the spectral filter described in relation to FIG. 3 for restricting the superimposition image to the specific spectral range instead of the actuation by the display controller. Accordingly, the superimposition image can be restricted to the specific spectral range by means of a suitable actuation of the display in the embodiment described in relation to FIG. 3. Likewise, the described procedures for restricting the spectral range in the image recorded by the at least one camera can be interchanged with one another in the respective embodiments. Moreover, there is the option of equipping the operation microscope with at least a first and a second camera and a first and a second display, wherein the specific spectral ranges of the superimposition images generated by the displays differ from one another and the spectral ranges in the images recorded by the two cameras also differ from one another. Furthermore, the image evaluation unit, which outputs an image in the visible spectral range in the exemplary embodiments, is also able to convert signals present in the visible spectral range into other wavelength signals. Therefore, the invention should not be restricted to the individual embodiments, but only by the attached claims.

### LIST OF REFERENCE SIGNS

1 Operation microscope
2 Main lens
3 Observation beam path
4 Superimposition beam path
5 Stereoscopic partial beam path
6 Stereoscopic partial beam path
7 Stereoscopic partial beam path
8 Stereoscopic partial beam path
9 Object field
11 Display
13 Display
14 Display controller
15 Beam guiding means
17 Eyepiece branch
19 Camera branch
21 Binocular tube
23 Eyepiece
24 Spectral filter
25 Camera
27 Camera
29 Diagonal surface
31 Illumination device
33 Light source
35 Illumination optical unit
37 Image evaluation unit
38 Control unit
39 Spectral filter
41 Spectral filter
43 Superimposition image
45 Object field image
47 Superposed image
49 Image processing unit
125 Camera

1. A method for operating an optical observation apparatus comprising at least one eyepiece, at least one camera and an observation beam path for displaying an object field image wherein a superimposition beam path representing an electronically generated superimposition image is superposed onto the observation beam path, wherein the observation beam path onto which the superimposition beam path has been superposed, has an eyepiece branch leading to the at least one eyepiece and a camera branch leading to the at least one camera and the at least one camera records an image on the basis of the camera branch, wherein the electronically generated superimposition image is only generated in a specific spectral range, or restricted to such a spectral range, which is substantially not also recorded by the at least one camera when recording the image or which is removed from the camera branch prior to recording the image with the at least one camera or which is removed from the image recorded by the at least one camera after recording the image using the at least one camera.

2. The method as claimed in claim 1, wherein a spectral range which is not present in the object field image or only present with a low intensity is selected as the specific spectral range.

3. The method as claimed in claim 1, wherein a spectral range which, compared to the spectral range of the object field image is a narrowband spectral range is selected as the specific spectral range.

4. The method as claimed in claim 1, wherein the specific spectral range is a section from the visible spectral range.

5. The method as claimed in claim 1, wherein
the spectral range in the image recorded by the at least one camera is restricted to 475 to 510 nm and 525 to 700 nm or a section thereof and the specific spectral range is a section from the visible spectral range which lies outside of the spectral range in the image recorded by the at least one camera
or
the spectral range in the image recorded by the at least one is restricted to 480 to 600 nm or a section thereof and the specific spectral range is a section from the visible spectral range which lies outside of the spectral range in the image recorded by the at least one camera
or
the spectral range in the image recorded by the at least one camera is restricted to 430 to 470 nm and 600 to 750 nm or a section thereof and the specific spectral range is a section from the visible spectral range which lies outside of the spectral range in the image recorded by the at least one camera
or
the spectral range in the image recorded by the at least one camera is restricted to 800 to 1000 nm or a section thereof and the specific spectral range is the visible spectral range or a section thereof.

6. The method as claimed in claim 1, wherein the superimposition image is generated on the basis of the image recorded by the at least one camera.

7. The method as claimed in claim 6, wherein
the specific spectral range is the visible spectral range or a section thereof and the spectral range in the image recorded by the at least one camera comprises the infrared spectral range and does not comprise the visible spectral range or the section of the visible spectral range forming the specific spectral range,
the image recorded by the camera is converted into an image in the visible spectral range or in the section of the visible spectral range which forms the specific spectral range, which image then serves as the electronically generated superimposition image, and
the superimposition beam path representing the electronically generated superimposition image is superposed onto the observation beam path in such a way that the electronically generated superimposition image is adapted to the dimension and position of the object field image.

8. The method as claimed in claim 7, wherein the image in the visible spectral range or in the section of the visible spectral range forming the specific spectral range, into which the recorded image is converted, is a grayscale value image, a color image with one or more colors or a contour image.

9. An optical observation apparatus, comprising:
at least one eyepiece,
at least one camera for recording images,
an observation beam path for displaying an object field image
at least one display which forms the initial point of a superimposition beam path representing an electronic superimposition image
an optical superposition device for superposing the superimposition beam path onto the observation beam path and
a beam splitter for forming an eyepiece branch, leading to the at least one eyepiece of the observation beam path, onto which the superimposition beam path has been superposed, and a camera branch leading to the at least one camera, of the observation beam path, onto which the superimposition beam path has been superposed,
wherein
the electronically generated superimposition image is only generated in a specific spectral range, or restricted to such a spectral range, and, for the purposes of generating the electronically generated superimposition image only in a specific spectral range or for the purposes of restricting the electronically generated superimposition image to the specific spectral range,
the at least one display is a display which can merely emit in the specific spectral range or
a display controller is assigned to the at least one display which display controller actuates said display for generating the electronically generated superimposition image in such a way that it only emits in the specific spectral range or
a filter which only passes the specific spectral range is disposed downstream of the at least one display,
and the spectral range in the image recorded by the at least one camera is restricted by virtue of
the at least one camera not being sensitive to the specific spectral range or the sensitivity of the camera being substantially lower to the specific spectral range than in other spectral ranges recorded by the camera, or
a filter for filtering out the specific spectral range from the camera branch of the observation beam path, onto which the superimposition beam path has been superposed, being present between the beam splitter and the at least one camera or
an image processing unit being present, which removes the specific spectral range from the image recorded by the at least one camera.

10. The optical observation apparatus as claimed in claim 9, wherein the at least one camera is sensitive in the visual spectral range and/or in the infrared spectral range.

11. The optical observation apparatus as claimed in claim 10, wherein
the spectral range in the image recorded by the at least one camera is restricted to 475 to 510 nm and 525 to 700 nm or a section thereof and the specific spectral range is a section from the visible spectral range which lies outside of the spectral range in the image recorded by the at least one camera
or
the spectral range in the image recorded by the at least one camera is restricted to 480 to 600 nm or a section thereof and the specific spectral range is a section from the visible spectral range which lies outside of the spectral range in the image recorded by the at least one camera
or
the spectral range in the image recorded by the at least one camera is restricted to 430 to 470 nm and 600 to 750 nm or a section thereof and the specific spectral range is a section from the visible spectral range which lies outside of the spectral range in the image recorded by the at least one camera
or
the spectral range in the image recorded by the at least one camera is restricted to 800 to 1000 nm or a section thereof and the specific spectral range is the visible spectral range or a section thereof.

12. The optical observation apparatus as claimed in claim 9, wherein an image evaluation unit connected to the at least one camera for receiving the recorded image is present, which image evaluation unit generates a superimposition image from the recorded image, and the image evaluation unit is connected to the display for displaying the generated superimposition image.

13. The optical observation apparatus as claimed in claim 12, wherein
the specific spectral range is the visible spectral range or a section thereof and the spectral range in the image recorded by the at least one camera comprises the infrared spectral range and does not comprise the visible spectral range or the section of the visible spectral range forming the specific spectral range,
the image evaluation unit is configured to convert the image recorded by the camera into an image in the visible spectral range or in the section of the visible spectral range which forms the specific spectral range, and to output the image in the visible spectral range or in the section of the visible spectral range which forms the specific spectral range to the at least one display and
the at least one display is arranged and/or the display controller actuates the at least one display in such a way that, when the superimposition beam path is superposed onto the observation beam path the electronically generated superimposition image is adapted to the dimension and position of the object field image.

14. The optical observation apparatus as claimed in claim 13, wherein the image in the visible spectral range or in the section of the visible spectral range forming the specific spectral range, into which the recorded image is converted, is a grayscale value image, a color image with one or more colors or a contour image.

15. The optical observation apparatus as claimed in claim 9, wherein the observation beam path and/or the superimposition beam path is a stereoscopic beam path/are stereoscopic beam paths.

16. The optical observation apparatus as claimed in claim 9, characterized by the configuration thereof as an operation microscope.
